(19) United States
(12) Patent Application Publication
(10) Pub. No.: US 2017/0150188 A1
(43) Pub. Date: May 25, 2017

(54) BROADCAST RECEIVING SYSTEM INCLUDING BROADCAST RECEIVING APPARATUS AND CONTROLLING METHOD THEREOF

(71) Applicant: SAMSUNG ELECTRONICS CO., LTD., Suwon-si (KR)

(72) Inventors: Keon-yong SEOK, Suwon-si (KR); Jung-jin KIM, Seoul (KR); In-kwon PAIK, Suwon-si (KR); Dong-hoon LEE, Suwon-si (KR); Yong-deok CHANG, Suwon-si (KR)

(73) Assignee: SAMSUNG ELECTRONICS CO., LTD., Suwon-si (KR)

(21) Appl. No.: 15/350,521

(22) Filed: Nov. 14, 2016

(30) Foreign Application Priority Data
Nov. 19, 2015 (KR) 10-2015-0162705

(51) Int. Cl. H04N 21/234; H04L 12/801; H04H 40/18; H04N 21/61; H04L 29/06

(52) U.S. Cl. CPC H04N 21/234; H04N 21/615; H04N 21/6125; H04N 21/6175; H04L 69/22; H04H 40/18; H04L 47/34

(57) ABSTRACT

A broadcast receiving system including a broadcast receiving apparatus and a controlling method thereof are disclosed. The broadcast receiving apparatus includes a tuner configured to receive a broadcast signal including broadcast data from a broadcast transmitting apparatus, a communicator configured to receive an additional signal including broadcast data and header information regarding the broadcast data from a reference apparatus, and a processor configured to determine the broadcast data included in the additional signal based on the header information and align the broadcast data received from the broadcast transmitting apparatus by using the broadcast data included in the additional signal.

### CROSS-REFERENCE TO RELATED APPLICATION

This application claims priority from Korean Patent Application No. 10-2015-0162705, filed in the Korean Intellectual Property Office on Nov. 19, 2015, the disclosure of which is incorporated herein by reference in its entirety.

### BACKGROUND

1. Field

Apparatuses and methods consistent with exemplary embodiments relate to a broadcast receiving system including a broadcast receiving apparatus and a controlling method thereof, and more particularly to a broadcast receiving system including a broadcast receiving apparatus by which a receiving function can be improved and a controlling method thereof.

2. Description of Related Art

According to developments of electronic technology and communications technology, various highly efficient devices have been developed. In broadcasting technology, high quality image of data and surround sound data can be provided to a user. Also, because there are many broadcast contents providers, users can watch various and realistic contents.

Many users live in cities with many buildings, including skyscrapers. Also, a broadcast receiving apparatus generally receives a radio frequency signal which is transmitted from a broadcasting station indoors. Therefore, it is hard for a user to watch broadcast contents without an error because the broadcast receiving apparatus receives a broadcast signal in a poor channel environment.

Accordingly, it is desirable to provide a technology to improve a receiving function of a broadcast receiving apparatus in a poor channel environment.

### SUMMARY

Methods and apparatuses consistent with exemplary embodiments relate to a broadcast receiving system including a broadcast receiving apparatus which can provide contents without an error by improving a receiving function of the broadcast receiving apparatus and a controlling method thereof.

According to an exemplary embodiment, there is provided a broadcast receiving apparatus, including a tuner configured to receive a broadcast signal including broadcast data from a broadcast transmitting apparatus, a communicator configured to receive an additional signal including broadcast data and header information regarding the broadcast data from a reference apparatus; and a processor configured to determine the broadcast data included in the additional signal based on the header information and align the broadcast data received from the broadcast transmitting apparatus using the broadcast data included in the additional signal.

The header information may include pattern information indicating whether the reference apparatus has received the broadcast data and sequence information indicating a sequence of the broadcast data included in the additional signal.

The processor may be further configured to detect the pattern information in the header information and, in response to the detected pattern information corresponding to a preset pattern, determine that the reference apparatus has received the broadcast data in the additional signal.

The processor may be further configured to determine a sequence of the broadcast data included in the additional signal based on the sequence information and align the broadcast data received from the broadcast transmitting apparatus based on the broadcast data included in the additional signal.

The apparatus may further include a display configured to correct an error of the aligned broadcast data and output an image based on the broadcast data.

The communicator may be further configured to receive the additional signal from the reference apparatus through at least one among Internet, Ethernet, Wi-Fi, Bluetooth or broadcast network of an idle broadcast band.

According to an aspect of another exemplary embodiment, there is provided a broadcast receiving system, including: a broadcast receiving apparatus configured to receive a broadcast signal including broadcast data from a broadcast transmitting apparatus; and a reference apparatus configured to receive a broadcast signal including broadcast data and signaling information regarding the broadcast data from the broadcast transmitting apparatus, the reference apparatus being further configured to delete the signaling information among the received broadcast signal, generate an additional signal by adding header information regarding the broadcast data and transmit the generated additional signal to the broadcast receiving apparatus, and the broadcast receiving apparatus being further configured to receive the additional signal from the reference apparatus and align the broadcast data received from the broadcast transmitting apparatus using the broadcast data included in the additional signal.

The header information may include pattern information indicating whether the reference apparatus has received the broadcast data and sequence information indicating a sequence of the broadcast data included in the additional signal.

The broadcast receiving apparatus may be further configured to detect the pattern information in the header information and, in response to the detected pattern information corresponding to a preset pattern, determine that the reference apparatus has received the broadcast data in the additional signal.

The broadcast receiving apparatus may be further configured to determine a sequence of the broadcast data included in the additional signal based on the sequence information and align the broadcast data received from the broadcast transmitting apparatus based on the broadcast data included in the additional signal.

The broadcast receiving apparatus may be further configured to correct an error of the aligned broadcast data and output an image based on the broadcast data.

The reference apparatus may be further configured to transmit the additional signal to the broadcast receiving apparatus through at least one among Internet, Ethernet, Wi-Fi, Bluetooth or broadcast network of an idle broadcast band.

According to an aspect of yet another exemplary embodiment, there is provided a method of controlling a broadcast receiving apparatus, the method including: receiving a broadcast signal including broadcast data from a broadcast transmitting apparatus; receiving an additional signal including broadcast data and header information regarding the broadcast data from a reference apparatus; determining the broadcast data included in the additional signal based on the header information; and aligning the broadcast data received from the broadcast transmitting apparatus using the broadcast data included in the additional signal.

The header information may include pattern information indicating whether the broadcast data that the reference apparatus has received is contained and sequence information indicating a sequence of the broadcast data included in the additional signal.

The determining may include detecting the pattern information in the header information and, in response to the detected pattern information corresponding a preset pattern, determining that the reference apparatus has received the broadcast data the additional signal.

The aligning may include determining a sequence of the broadcast data included in the additional signal based on the sequence information and aligning the broadcast data received from the broadcast transmitting apparatus based on the broadcast data included in the additional signal.

The method may further include correcting an error of the aligned broadcast data and outputting an image based on the broadcast data.

The receiving from the reference apparatus may include receiving the additional signal from the reference apparatus through at least one among Internet, Ethernet, Wi-Fi, Bluetooth or broadcast network of an idle broadcast band.

According to various exemplary embodiments, a receiving function of a broadcast receiving apparatus may be improved.

### BRIEF DESCRIPTION OF THE DRAWINGS

FIG. 1 is a view indicating a broadcast system according to an exemplary embodiment;

FIG. 2 is a block diagram of a broadcast receiving apparatus according to an exemplary embodiment;

FIG. 3 is a block diagram of a broadcast receiving apparatus according to another exemplary embodiment;

FIGS. 4A, 4B and 4C are views explaining a process of transmitting a broadcast signal;

FIG. 5 is a view explaining a process of a reference apparatus generating an additional signal according to an exemplary embodiment;

FIG. 6 is a view explaining a process of aligning broadcast data in a broadcast receiving apparatus according to an exemplary embodiment;

FIG. 7 is a timing chart of a broadcast receiving system according to an exemplary embodiment;

FIG. 8 is a flowchart of a controlling method of a broadcast receiving apparatus according to an exemplary embodiment; and

FIG. 9 is a flowchart explaining a process of aligning broadcast data according to an exemplary embodiment.

### DETAILED DESCRIPTION OF EXEMPLARY EMBODIMENTS

Exemplary embodiments will be described in more details with reference to the drawings accompanying herewith. Although specific exemplary embodiments are illustrated and discussed in detail in the detailed description, exemplary embodiments may be variously modified.

The specific exemplary embodiments illustrated in the attached drawings are only to help people understand the various exemplary embodiments. Therefore, a technical idea of the disclosure is not limited to the specific exemplary embodiments illustrated in the attached drawings, and it should be understood that all modifications, equivalents, and alternatives without departing from the scope and spirit of the exemplary embodiments are included. In describing exemplary embodiments, detailed descriptions of well-known technologies are not provided in detail because this would obscure exemplary embodiments with unnecessary details.

Although the terms such as “first” and “second” may be used to explain various elements, the elements should not be limited by these terms. These terms are used for the purpose of distinguishing one element from another element.

It should be understood that terms such as “comprise” or “consist of” as used herein designate presence of characteristics, numbers, steps, operations, elements, components or a combination thereof described herein, and do not foreclose the presence or possibility of addition of one or more other characteristics, numbers, steps, operations, elements, components or a combination thereof. When it is described as a certain element “is connected” to another element or “access” another element, the certain element may be directly connected or access the element, but another element (a third element) may also exist between the certain element and the other element. However, when it is described as one element “is directly connected to” or “directly access” another element, it should be understood that element exists between the two elements.

Meanwhile, in exemplary embodiments, “a module” or “a unit” operates at least one function or operation. Also, “a module” or “a unit” operates at least one function or operation by hardware, software or a combination of hardware and software. A plurality of “modules” or “units” can be embodied as at least one of processor by being integrated in at least one module except for “a module” or “a unit” which needs to be embodied as certain hardware.

A singular expression may include a plural expression, unless otherwise specified in context.

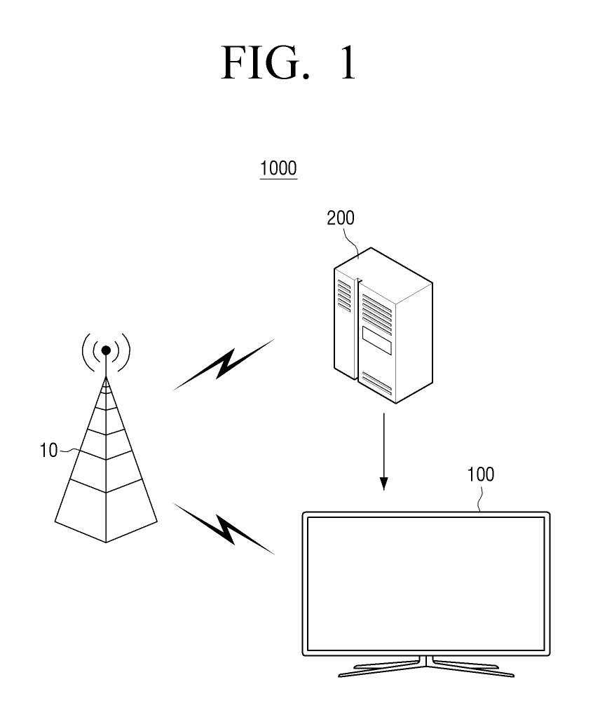

FIG. 1 is a view indicating a broadcast system according to an exemplary embodiment.

FIG. 1 illustrates a broadcast receiving system 1000. The broadcast receiving system 1000 includes a broadcast transmitting apparatus 10, a reference apparatus 200 and a broadcast receiving apparatus 300. The broadcast transmitting apparatus 10 outputs a broadcast signal. The broadcast signal may include signaling information indicating broadcast data and information regarding the broadcast data. For example, the broadcast transmitting apparatus 10 may include a contents providing apparatus which outputs broadcast data to a broadcast station and a broadcast communications band.

A broadcast signal outputted from the broadcast transmitting apparatus 10 may be received in the reference apparatus 200 and the broadcast receiving apparatus 100. According to circumstances, the broadcast signal may be transmitted to the reference apparatus 200 and the broadcast receiving apparatus 100 through a base station or a repeater. The reference apparatus 200 and the broadcast receiving apparatus 100 may receive a broadcast signal. According to circumstances, the broadcast receiving apparatus 100 may receive a broadcast signal through a set top box.

The reference apparatus 200 may include a server, a television (TV) and so on. The reference apparatus 200 may receive a broadcast signal which is outputted from the broadcast transmitting apparatus 10. For example, the reference apparatus 200 may be an apparatus which is equipped at a place where a broadcast receiving condition is satisfactory or including a high quality antenna. Therefore, the reference apparatus 200 may receive a broadcast signal of a satisfactory quality which has almost no error from the broadcast transmitting apparatus 10. The broadcast receiving apparatus 100 may receive a broadcast signal which is outputted from the broadcast transmitting apparatus 10. The broadcast receiving apparatus 100 indicates an apparatus for a user to watch a broadcasting program. Therefore, the broadcast receiving apparatus 100 may be installed in a house and receive a broadcast signal of a relatively poor quality. For example, the broadcast receiving apparatus 100 may include a smartphone, a laptop computer, a tablet personal computer (PC), a personal digital assistants (PDA), a portable multimedia player (PMP), a navigation, an ultrabook, a wearable apparatus, a TV, a kiosk, and the like.

The reference apparatus 200 and the broadcast receiving apparatus 100 may receive an identical broadcast signal from the broadcast transmitting apparatus 10. The reference apparatus 200 may extract broadcast data from the received broadcast signal. In other words, the reference apparatus 200 may delete signaling information regarding the broadcast data in the received broadcast signal. The reference apparatus 200 may generate an additional signal. The additional signal may include the broadcast data and header information. In other words, the reference apparatus 200 may further add the header information in the extracted broadcast data. The header information may include information which indicates that the data is the broadcast data and information indicating a frame sequence of the broadcast data. The reference apparatus 200 may transmit a generated additional signal to the broadcast receiving apparatus 100. Because the broadcast signal should be transmitted to a distant area in a form of an analogue signal, the more it is error-resistant, the more information can be contained. However, because an additional signal is transmitted to an apparatus in a short distance in a form of a digital signal, the minimum header information may be contained. Therefore, amount of data in the additional signal is smaller than amount of data in a broadcast signal, and the additional signal may be transmitted at low bandwidths.

The broadcast receiving apparatus 100 may receive a broadcast signal including broadcast data from the broadcast transmitting apparatus 10. The broadcast receiving apparatus 100 may receive an additional signal including broadcast data from the reference apparatus 200. As described the above, the broadcast data included in the additional signal is data identical to the broadcast data included in the broadcast signal. However, the broadcast data included in the additional signal may be data that has fewer errors than the broadcast data included in the broadcast signal.

The broadcast receiving apparatus 100 may align the broadcast data included in the broadcast signal by using the broadcast data included in the additional signal. The expression “align” may be expressed as “synchronize.” In other words, the broadcast receiving apparatus 100 may compare the same frames of the broadcast data included in the broadcast signal and the broadcast data included in the additional signal. Or, the broadcast receiving apparatus 100 may correct the broadcast data and an error included in the broadcast signal by using the broadcast data included in the additional signal.

The broadcast receiving system 1000 may improve a receiving function of the broadcast receiving apparatus 100 and output broadcast data with no error through the methods. Hereinafter, the block diagram of the broadcast receiving apparatus 100 is described in detail.

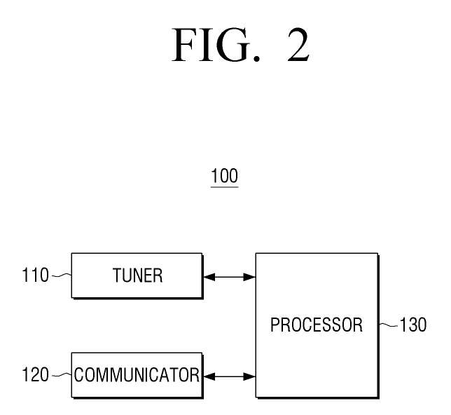

FIG. 2 is a block diagram of a broadcast receiving apparatus according to an exemplary embodiment.

FIG. 2 illustrates that the broadcast receiving apparatus 100 includes a tuner 110, a communicator 120 and a processor 130. The tuner 110 receives a broadcast signal including broadcast data from a broadcast transmitting apparatus. The tuner 110 selects a broadcast signal which pertains to a channel which is selected by a user or all pre-stored channels among broadcast signals received from an antenna.

The communicator 120 receives an additional signal from a reference apparatus. The additional signal includes header information regarding broadcast data that the reference apparatus received and broadcast data generated in the reference apparatus. In other words, the broadcast receiving apparatus 100 receives the broadcast data that the reference apparatus received and header information regarding the broadcast data through the communicator 120. The communicator 120 may include at least one module which enables a wireless communication between the reference apparatus and the broadcast receiving apparatus 100. The communicator 120 may connect the reference apparatus and the broadcast receiving apparatus 100 by using wired or wireless communications method. For example, the wireless communications method may include a wireless LAN (WLAN), a wireless-fidelity (Wi-Fi), Wi-Fi direct, Digital Living Network Alliance (DLAN), Wireless Broadband (WiBro), World Interoperability for Microwave Access (WiMAX), High Speed Downlink Packet Access (HSDPA), High Speed Uplink Packet Access (HSUPA), Bluetooth, ZigBee, a Wireless Universal Serial Bus (Wireless USB). The communicator 120 may be connected to the reference apparatus by using the Internet, the Ethernet or broadcast network of an idle broadcast band.

The processor 130 determines the broadcast data included in the additional signal based on the header information. The processor 130 aligns the broadcast data received from the broadcast transmitting apparatus by using the broadcast data included in the additional signal.

The processor 130 receives the broadcast signal received from the broadcast transmitting apparatus from the tuner 110. The processor 130 demodulates the broadcast signal received from the tuner 110 and parses the broadcast data. The processor 130 receives the additional signal including the broadcast data from the communicator 120. The additional signal includes the broadcast data that the reference apparatus received and header information regarding the broadcast data. The processor 130 may determine the broadcast data in the additional signal by using the header information in the additional signal. The processor 130 may distinguish a frame sequence of the broadcast data in the additional signal and align a frame of the broadcast data in a corresponding broadcast signal. The processor 130 may correct an error of the broadcast data in the broadcast signal based on the aligned frame.

For example, the processor 130 may determine an error part of the broadcast data in the broadcast signal and replace with the broadcast data in the corresponding additional signal. The processor 130 may calculate an exact data value in the frame in a discrete method (or in a digital method) by synchronizing the broadcast data in the additional signal which corresponds to the broadcast data in the broadcast signal. For example, a first pixel value of a first frame of an original broadcast data may be zero (0). However, the first pixel value of the first frame of the broadcast data in the broadcast signal may have value of 0.5 because of an error. A first pixel value of a first frame of the broadcast data in the additional signal may be zero (0). Therefore, when the first pixel value of the first frame of the broadcast data in the broadcast signal is added to the first pixel value of the first frame of the broadcast data in the additional signal, the value is 0.5 and when the value is divided by two, because the two values are added, the value becomes 0.25. Because the discrete method (or a digital method) only has values of 0 and 1, 0.25 may seem as zero (0). Therefore, the processor 130 may set the first pixel value of the first frame of the broadcast data of the broadcast signal as zero (0).

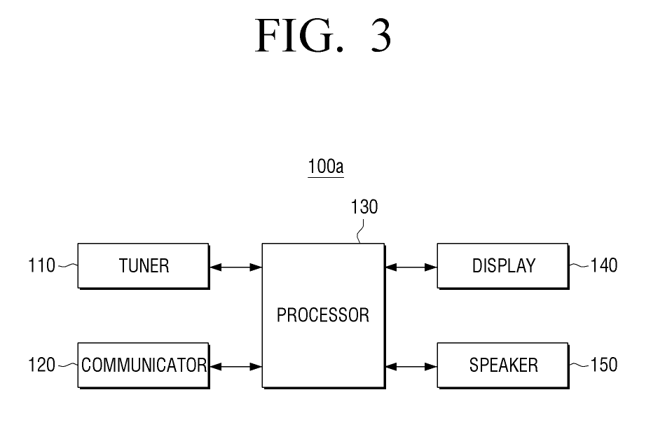

FIG. 3 is a block diagram of a broadcast receiving apparatus according to another exemplary embodiment.

FIG. 3 illustrates that a broadcast receiving apparatus 100a includes the tuner 110, the communicator 120, the processor 130, a display 140 and a speaker 150.

The tuner 110 may receive a broadcast signal from a broadcast transmitting apparatus. The broadcast signal that the tuner 110 receives may include broadcast data regarding one channel selected by a user among a plurality of broadcast channels.

The communicator 120 may receive a signal from an external apparatus. For example, the communicator 120 may receive an additional signal including broadcast data that a reference apparatus received, from the reference apparatus.

The processor 130 may process the broadcast signal received from the broadcast transmitting apparatus and the additional signal received from the reference apparatus. The processor 130 may separate the broadcast data from the broadcast signal which was received from the broadcast transmitting apparatus. The processor 130 may detect the broadcast data by decoding the broadcast signal and parsing the decoded broadcast signal. The processor 130 may distinguish image data and audio data among the detected broadcast data.

The processor 130 may separate the broadcast data from the additional signal received from the reference apparatus. The processor 130 may detect the broadcast data included in the additional signal by using header information included in the additional signal. The processor 130 may align the broadcast data included in the broadcast signal by using the broadcast data included in the additional signal. In other words, the processor 130 may align the image data in the broadcast data. The processor 130 may correct an error in the aligned broadcast data. The processor 130 may transmit corrected image data in the broadcast data to the display 140 and transmit the audio data to the speaker 150.

The display 140 may output a corrected image data. In other words, the display 140 may output the corrected broadcast data. The speaker 150 may output the audio data.

Hereinabove, the block diagram of the broadcast receiving apparatus is described. Hereinafter, a process of aligning broadcast data is described.

A broadcast receiving apparatus of a receiving system including a reference apparatus and a broadcast receiving apparatus may receive an additional signal including broadcast data from the reference apparatus and receive a broadcast signal from the broadcast transmitting apparatus. It is generally very hard for a broadcast receiving apparatus to align broadcast data in an additional signal received from a reference apparatus and broadcast data in a broadcast signal. Because an additional signal is transmitted to a broadcast receiving apparatus on the Internet, by Wi-Fi or through broadcast bandwidth of White space, a network delay may occur. In other words, there may be a time difference between the additional signal and the broadcast signal transmitted from the broadcast transmitting apparatus. Therefore, the disclosure suggests a method of synchronizing and aligning the broadcast data of the additional signal and the broadcast data of the broadcast signal by which time difference is generated.

In all satellite broadcasting standards, in order for a broadcast receiving apparatus to easily synchronize and decode broadcast data receiving from a broadcast transmitting apparatus, it is regulated that signaling information and a pilot signal is regularly transmitted. Therefore, the reference apparatus does not need to separately send signaling information regarding broadcast data to the broadcast receiving apparatus. Because the reference apparatus does not use a section for the signaling information in the broadcast signal received from the broadcast transmitting apparatus, the section for the signaling information may be used as an information inserting section for synchronization of the broadcast receiving apparatus. In other words, the reference apparatus may transmit the additional signal including the header information and the broadcast data to the broadcast receiving apparatus by inserting the header information regarding the broadcast data which is transmitted to the broadcast receiving apparatus in the section for the signaling information. The broadcast receiving apparatus may receive the additional signal from the reference apparatus and synchronize and align the broadcast data in the broadcast signal and the broadcast data in the additional signal by using the header information in the additional signal. In other words, the broadcast receiving apparatus may determine a correlation between the broadcast data in the additional signal and the broadcast data in the broadcast signal based on the header information and calculate a delayed time between the two pieces of data. The broadcast receiving apparatus may synchronize and align the broadcast data in the additional signal and the broadcast data in the broadcast signal based on the correlation and the delayed time.

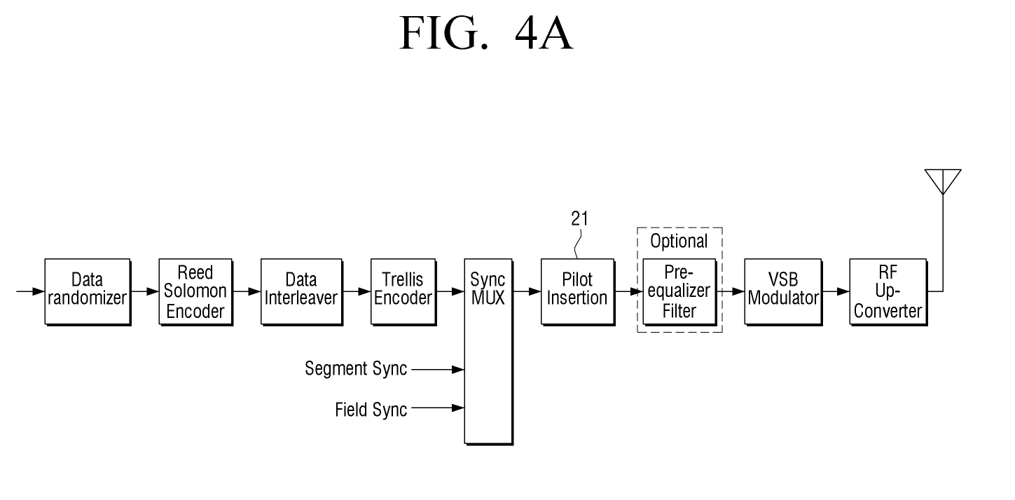

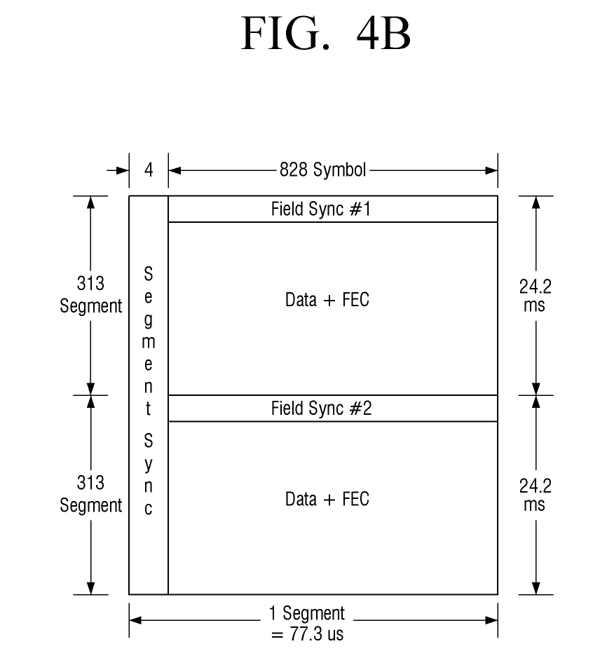

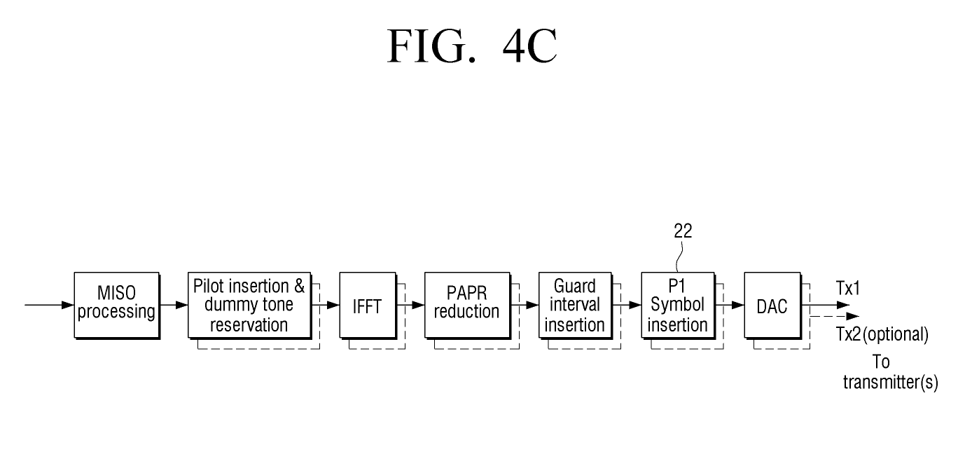

FIGS. 4A, 4B and 4C are views explaining a process of transmitting a broadcast signal.

FIG. 4A illustrates a block diagram for a digital broadcast standard of Advanced Television System Committee (ATSC). A broadcast signal modulation of 8-Vesigial Side Band (ATSC-8VSB) which is a traditional digital broadcasting method for North American broadcast televisions may include a process of Data Randomizer, Reed-Solomon Encoder, Data Interleaver, Trellis Encoder, Sync MUX, Pilot Insertion, Pre-equalizer Filter, VSB Modulator and radio frequency (RF) Up-converter.

An input signal of a modulator may be MPEG-2 transport stream (TS) of 19.39 Mbps. The Data Randomizer may reduce a possibility of an error by deleting repetitive patterns of fixed values such as 0000 and 1111. In other words, the Data Randomizer may reduce an intervention when modulating data by evenly distributing radio frequency energy to channels. The Reed-Solomon Encoder is one of block coding methods and may add parity of 20 bytes per block by binding a packet (for example, 187 bytes) as a block. The Data Interleaver may prevent data loss by a burst error. The Trellis Encoder is one of convolution coding methods and may generate a coding calculation value of 1 bit by referring to previous 2 bits for every 2 bits. In other words, 1 redundancy bit may be further added.

The Sync MUX may insert Segment Sync and Field Sync in order to help detecting and decoding an RF signal in a receiving apparatus. The Pilot Insertion 21 may insert a pilot signal which is a certain pilot pattern in order for a receiving apparatus to estimate a transmission channel and synchronize time and frequency. The Pre-equalizer Filter may be selectively used as a process to compensate a decrease of signal to noise ratio (SNR). The VSB Modulator may generate an intermediate frequency (IF) signal by carrying out an amplitude modulation for 8-VSB signal including signaling information in which a synchronization signal is included. The RF Up-converter may convert the generated IF signal to a wanted channel frequency and output the channel frequency. An inserted pilot insertion area which was inserted in the process of the pilot insertion 21 may be a regular signaling information or a pilot section. For example, a reference apparatus may use a pilot area which is inserted in the process of the pilot insertion 21 as an area for inserting header information.

FIG. 4B illustrates a structure of an ATSC data frame. A pilot insertion area may be a frame structure which is identical to the frame structure illustrated in FIG. 4B. In other words, the pilot insertion area may regularly transmit a field sync signal per 24.2 ms.

FIG. 4C illustrates a block diagram for a digital broadcast standard of Digital Video Broadcasting-Terrestrial version 2 (DVB-T2). A modulation of a signal of the DVB-T2 broadcast which is a digital broadcast transmitting method of European terrestrial broadcasting may include a process of MISO processing, Pilot insertion & dummy tone reservation, Inverse Fast Fourier Transform (IFFT), Peak-to-Average Power Ratio (PAPR) reduction, Guard interval insertion, P1 Symbol insertion and Digital-to-Analog Conversion (DAC).

The MISO processing may selectively apply an alamouti pre-processing to a pair of orthogonal frequency division multiplexing (OFDM) symbol cells. The Pilot insertion & dummy tone reservation may insert a pilot signal of a certain pilot pattern to a signal frame in order for a receiving apparatus to carry out estimating a transmission channel and synchronizing time and frequencies. A plurality of dummy carriers may not be modulated or reserved to reduce a dynamic range of a DVB-T2 output signal. A signal in which a pilot is inserted may be converted to a time area through the IFFT. The PAPR reduction may reduce PAPR of signals in a time area. The Guard interval insertion is a process of inserting a guard interval of a cyclic prefix form by copying the last part of the OFDM symbol in a forepart of the OFDM symbol. P1 Symbol insertion 22 indicates inserting a P1 symbol at a starting part of a signal frame. The DAC may convert the signal frame to an analogue signal and transmit the signal through an antenna. For example, a reference apparatus may use a pilot area which is inserted in the P1 Symbol insertion 22 as an area to insert header information. In other words, the reference apparatus may insert header information by using a regularly signaled information section even in the DVB-T2 broadcast standard. Therefore, the broadcast receiving apparatus may receive header information that the reference apparatus inserted and easily synchronize two pieces of broadcast data.

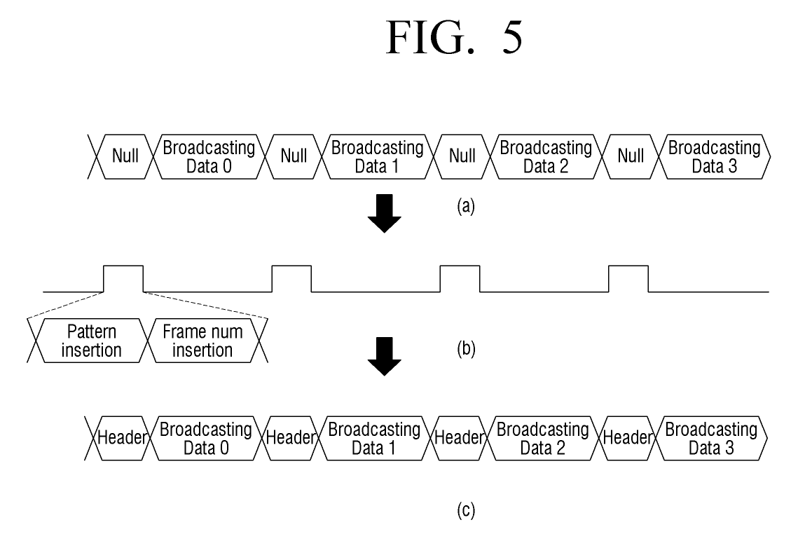

FIG. 5 is a view explaining a process of a reference apparatus generating an additional signal according to an exemplary embodiment.

Section (a) of FIG. 5 illustrates broadcast data that a reference apparatus received from a broadcast transmitting apparatus. The reference apparatus may receive a broadcast signal including broadcast data and signaling information regarding the broadcast data, from the broadcast transmitting apparatus. The broadcast signal that the reference apparatus receives may be the identical broadcast signal that the broadcast receiving apparatus receives. The broadcast data included in the broadcast signal that the reference apparatus received may be the broadcast data identical to the broadcast data that the broadcast receiving apparatus receives. The reference apparatus may receive the broadcast signal from the broadcast transmitting apparatus, carry out a demodulation and decoding process, and extract broadcast data. In other words, a data area of a broadcast signal may include broadcast data but an information area of the broadcast signal may not include any data (Null area).

Section (b) of FIG. 5 illustrates header information that the reference apparatus inserts. For example, the header information may include pattern information and sequence information. The pattern information may be information indicating whether broadcast data is included. When the reference apparatus transmits a signal to a broadcast receiving apparatus through communications network, a digital signal may be transmitted. The broadcast receiving apparatus may receive a series of digital signals from the reference apparatus and if there is no preset rule, the received signals may not be determined to any signal. Therefore, the reference apparatus may indicate that a signal which is transmitted by using pattern information is a signal including broadcast data. The pattern information may include a regular pattern value which is preset. For example, the pattern information may be set as “010001000111.” Therefore, the reference apparatus may indicate that a signal which is transmitted by pattern information being inserted in header information is a signal including broadcast data. The broadcast receiving apparatus may, in response to the pattern information being included in the header information, recognize that the received signal is the signal including the broadcast data.

Meanwhile, the header information may include sequence information. The sequence information is information indicating a sequence of broadcast data. In other words, the sequence information may be information indicating an order of the broadcast data that is currently transmitted. The reference apparatus and the broadcast receiving apparatus may receive an identical broadcast signal from a broadcast transmitting apparatus. Broadcast signals that the reference apparatus and the broadcast receiving apparatus receive may include identical broadcast data. The broadcast data that the reference apparatus received may have fewer errors comparing to the broadcast data that the broadcast receiving apparatus received. Therefore, the broadcast receiving apparatus may align its own broadcast data by using the broadcast data received from the reference apparatus. Herein, the broadcast receiving apparatus should align broadcast data of an identical frame. The broadcast receiving apparatus should be able to know an order of the frame to which the broadcast data received from the reference apparatus pertains. The reference apparatus may insert sequence information to header information. The reference apparatus may use sequence information of a frame included in the broadcast signal received from the broadcast transmitting apparatus. The broadcast receiving apparatus may align the broadcast data based on the sequence information inserted in the header information.

Section (c) of FIG. 5 illustrates an additional signal. The reference apparatus may generate header information including pattern information and sequence information. The reference apparatus may generate an additional signal including the header information and broadcast data. The reference apparatus may insert the header information in signaling area (or a pilot area) of the broadcast signal. The reference apparatus may transmit the generated additional signal to the broadcast receiving apparatus. For example, the reference apparatus may transmit the additional signal to the broadcast receiving apparatus by using technology of the Internet, the Ethernet, the Wi-Fi, the Bluetooth or White space.

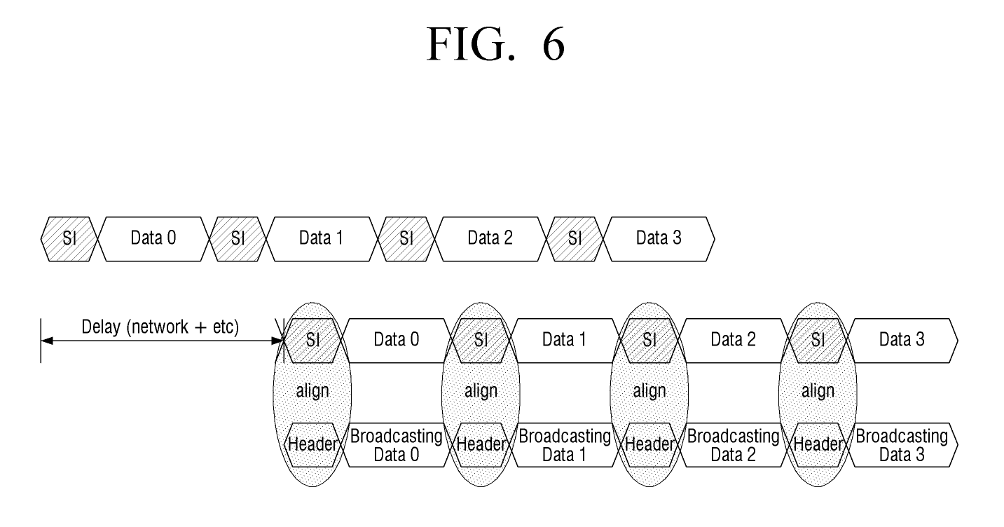

FIG. 6 is a view explaining a process of aligning broadcast data in a broadcast receiving apparatus according to an exemplary embodiment.

FIG. 6 illustrates an additional signal received from a reference apparatus and a broadcast receiving apparatus that aligns broadcast data by using the additional signal. As described the above, the additional signal may include header information and broadcast data. Because broadcast data that the reference apparatus has received is generated as an additional signal by being processed in the reference apparatus and transmitted to the broadcast receiving apparatus through network, the broadcast data may be delayed comparing to broadcast data of the broadcast receiving apparatus. The broadcast receiving apparatus may receive the additional signal from the reference apparatus. The broadcast receiving apparatus may detect header information included in the additional signal. The broadcast receiving apparatus may determine that the received additional signal is a signal including broadcast data based on pattern information included in the header information. The broadcast receiving apparatus may synchronize and align corresponding broadcast data based on sequence information included in the header information. In other words, a broadcast receiving system may, in response to the header information being inserted by using a signaling area (or a pilot area) of a broadcast signal, easily align and synchronize the broadcast data by reducing cost (e.g. memory capacity additions) according to a data delay and controlling time for complexity.

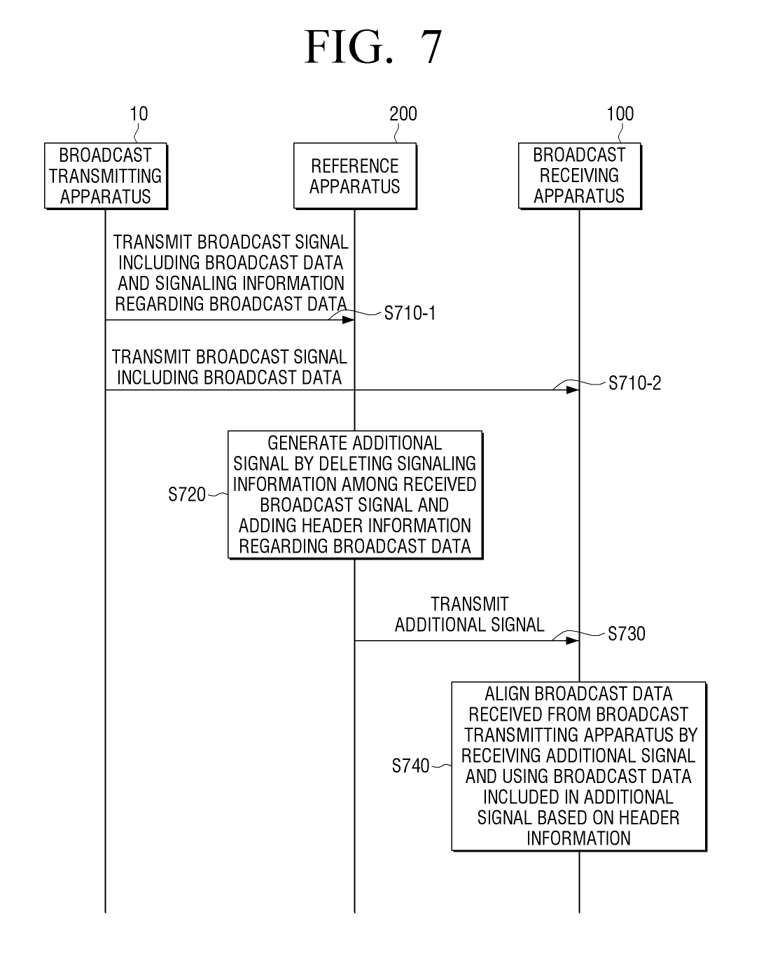

FIG. 7 is a timing chart of a broadcast receiving system according to an exemplary embodiment.

FIG. 7 illustrates that a broadcast receiving system includes the broadcast transmitting apparatus 10, the reference apparatus 200 and the broadcast receiving apparatus 100. The broadcast transmitting apparatus 10 may transmit a broadcast signal including broadcast data and signaling information regarding the broadcast data (S710-1, S710-2). The broadcast transmitting apparatus 10 may output the broadcast signal through all apparatuses that can receive broadcasting without assigning a specific apparatus. The broadcast signal may include signaling information indicating the broadcast data and information regarding the broadcast data.

The reference apparatus may generate an additional signal by deleting the signaling information among the received broadcast signal and adding header information regarding the broadcast data (S720). The header information may include pattern information and sequence information. The pattern information may be information indicating that broadcast data is included in the additional signal and the sequence information may be information indicating a frame sequence of the broadcast data. The reference apparatus may extract the sequence information from the signaling information included in the broadcast signal and insert the information in the header information. The reference apparatus may transmit the additional signal to the broadcast receiving apparatus (S730).

The broadcast receiving apparatus may align the broadcast data received from the broadcast transmitting apparatus by receiving the additional signal and using the broadcast data included in the additional signal based on the header information (S740). The broadcast receiving apparatus may align the broadcast data included in the broadcast signal and the broadcast data included in the additional signal. The broadcast receiving apparatus may align two pieces of broadcast data by using the header information included in the additional signal. The broadcast receiving apparatus may correct an error of the broadcast data included in the broadcast signal by aligning the two pieces of broadcast data and using the broadcast data included in the additional signal. The broadcast receiving apparatus may replace the broadcast data included in the broadcast data with the broadcast data included in the additional signal. Therefore, a user can watch the broadcast content in which the error is corrected or the broadcast content which is replaced with the broadcast data of the additional signal. In other words, the user can watch a broadcast content whose reception quality is improved.

Hereinabove, the various exemplary embodiments of the broadcast receiving system including the reference apparatus and the broadcast receiving apparatus and the controlling methods are described. Hereinafter, a flowchart regarding a controlling method and an aligning process of a broadcast receiving apparatus will be described.

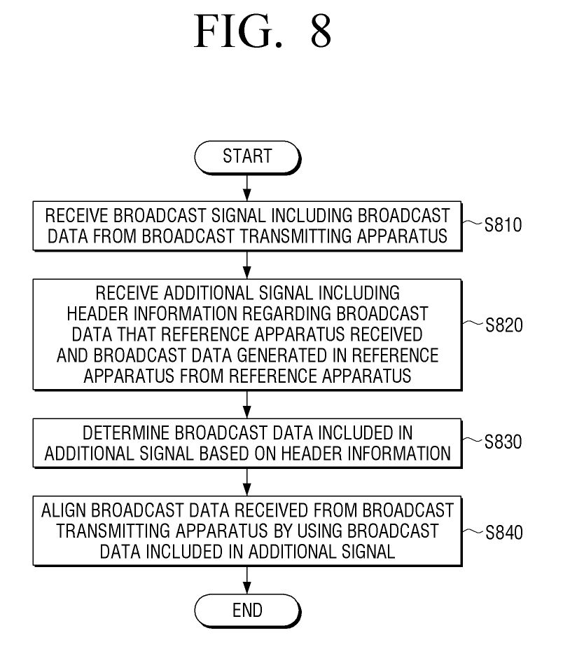

FIG. 8 is a flowchart of a controlling method of a broadcast receiving apparatus according to an exemplary embodiment.

FIG. 8 illustrates that the broadcast receiving apparatus receives a broadcast signal including broadcast data from a broadcast transmitting apparatus (S810). The broadcast receiving apparatus receives an additional signal including header information regarding broadcast data that a reference apparatus received and broadcast data generated in the reference apparatus, from the reference apparatus (S820). The reference apparatus may delete signaling information by receiving the broadcast signal from the broadcast transmitting apparatus. The reference apparatus may generate an additional signal by inserting header information to a signaling information area (or a pilot area). The header information may include pattern information and sequence information. The pattern information may be information indicating whether the broadcast data that the reference apparatus received is included. The sequence information may be information indicating a sequence of the broadcast data included in the additional signal. The reference apparatus may transmit the additional signal to the broadcast receiving apparatus.

The broadcast receiving apparatus may determine the broadcast data included in the additional signal based on the header information (S830). The broadcast receiving apparatus may detect the pattern information in the header information and, in response to the detected pattern information being a preset pattern, determine that the additional signal includes the broadcast data. The broadcast receiving apparatus aligns the broadcast data received from the broadcast transmitting apparatus by using the broadcast data included in the additional signal (S840). The broadcast receiving apparatus may determine a sequence of the broadcast data included in the additional signal based on the sequence information. The broadcast receiving apparatus may align the broadcast data included in the additional signal and the broadcast data included in the broadcast signal. The broadcast receiving apparatus may correct an error in the broadcast data included in the broadcast signal based on the broadcast data in the additional signal. The broadcast receiving apparatus may replace the broadcast data included in the broadcast signal with the broadcast data included in the additional signal. The broadcast receiving apparatus may output the broadcast data in which the error was corrected.

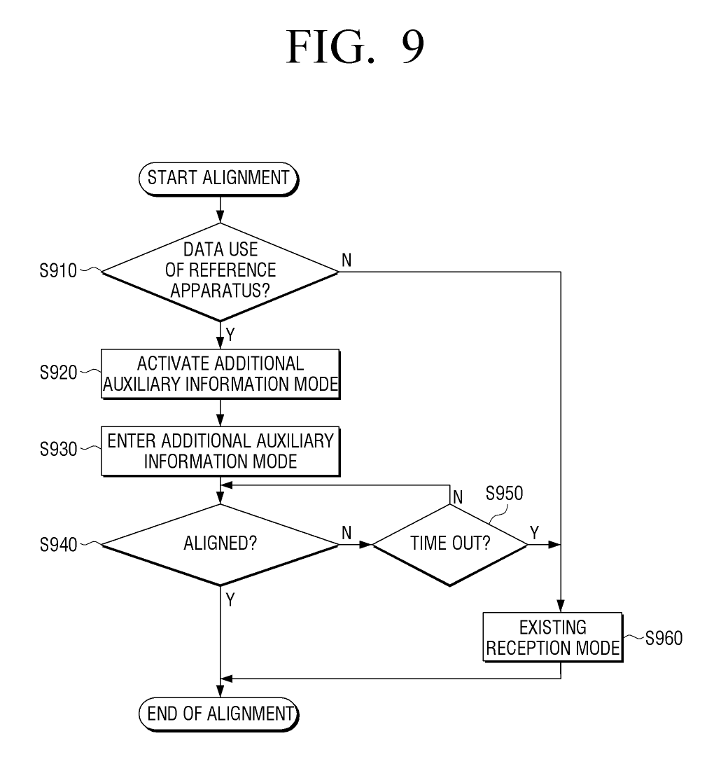

FIG. 9 is a flowchart explaining a process of aligning broadcast data according to an exemplary embodiment.

Referring to FIG. 9, a broadcast receiving apparatus may receive an input of a selection command regarding whether to use data of a reference apparatus from a user (S910). In response to a use of data of the reference apparatus being selected, the broadcast receiving apparatus may activate an additional auxiliary information mode (S920). In response to the use of data of the reference apparatus not being selected, the broadcast receiving apparatus may maintain an existing reception mode (S960). The broadcast receiving apparatus may enter the additional auxiliary information mode (S930). The broadcast receiving apparatus may receive an additional signal from the reference apparatus. The broadcast receiving apparatus may align the broadcast data by using information and data of the additional signal (S940). The broadcast receiving apparatus may, in response to the alignment of the broadcast data not being carried out, determine whether a timeout occurred (S950). If a timeout not occurs, the broadcast receiving apparatus may continuously try to align the broadcast data. In response to a time out occurring, the broadcast receiving apparatus may change its mode to the existing reception mode (S960).

The various exemplary embodiments of the controlling methods of the broadcast receiving apparatus may be embodied as programs and be provided to the broadcast receiving apparatus.

For example, a non-transitory computer readable medium which executes receiving a broadcast signal including broadcast data from a broadcast transmitting apparatus, receiving an additional signal including broadcast data that a reference apparatus has received and header information regarding the broadcast data generated from the reference apparatus, from the reference apparatus, determining the broadcast data included in the additional signal based on the header information, and aligning the broadcast data received from the broadcast transmitting apparatus by using the broadcast data included in the additional signal may be provided.

The non-transitory computer readable medium refers to a medium that stores data semi-permanently rather than storing data for a short time, such as a register, a cache, a memory, or etc., and is readable by an apparatus. Specifically, the above-described various applications or programs may be stored in the non-transitory computer readable medium such as a compact disc (CD), a digital versatile disc (DVD), a hard disk, a Blu-ray disk, a universal serial bus (USB), a memory card, a ROM or etc.

While exemplary embodiments of this disclosure have been illustrated and described, it will be understood by those skilled in the art that various changes in form and details can be made therein without departing from the spirit and scope of the present disclosure as defined by the appended claims. Therefore, the scope of the disclosure is defined not by the detailed description of exemplary embodiments, but by the appended claims, and all differences within the scope will be construed as being included in the present disclosure.

What is claimed is:

1. A broadcast receiving apparatus, comprising:
a tuner configured to receive a broadcast signal including broadcast data from a broadcast transmitting apparatus;
a communicator configured to receive an additional signal including broadcast data and header information regarding the broadcast data from a reference apparatus; and
a processor configured to determine the broadcast data included in the additional signal based on the header information and align the broadcast data received from the broadcast transmitting apparatus using the broadcast data included in the additional signal.

2. The apparatus as claimed in claim 1, wherein the header information includes pattern information indicating whether the reference apparatus has received the broadcast data and sequence information indicating a sequence of the broadcast data included in the additional signal.

3. The apparatus as claimed in claim 2, wherein the processor is further configured to detect the pattern information in the header information and, in response to the detected pattern information corresponding to a preset pattern, determine that the reference apparatus has received the broadcast data in the additional signal.

4. The apparatus as claimed in claim 3, wherein the processor is further configured to determine a sequence of the broadcast data included in the additional signal based on the sequence information and align the broadcast data received from the broadcast transmitting apparatus based on the broadcast data included in the additional signal.

5. The apparatus as claimed in claim 4, further comprising a display configured to correct an error of the aligned broadcast data and output an image based on the broadcast data.

6. The apparatus as claimed in claim 1, wherein the communicator is further configured to receive the additional signal from the reference apparatus through at least one among Internet, Ethernet, Wi-Fi, Bluetooth or broadcast network of an idle broadcast band.

7. A broadcast receiving system, comprising:
a broadcast receiving apparatus configured to receive a broadcast signal including broadcast data from a broadcast transmitting apparatus; and
a reference apparatus configured to receive a broadcast signal including broadcast data and signaling information regarding the broadcast data from the broadcast transmitting apparatus,
wherein the reference apparatus is further configured to delete the signaling information among the received broadcast signal, generate an additional signal by adding header information regarding the broadcast data and transmit the generated additional signal to the broadcast receiving apparatus, and
wherein the broadcast receiving apparatus is further configured to receive the additional signal from the reference apparatus and align the broadcast data received from the broadcast transmitting apparatus using the broadcast data included in the additional signal.

8. The system as claimed in claim 7, wherein the header information includes pattern information indicating whether the reference apparatus has received the broadcast data and sequence information indicating a sequence of the broadcast data included in the additional signal.

9. The system as claimed in claim 8, wherein the broadcast receiving apparatus is further configured to detect the pattern information in the header information and, in response to the detected pattern information corresponding to a preset pattern, determine that the reference apparatus has received the broadcast data in the additional signal.

10. The system as claimed in claim 9, wherein the broadcast receiving apparatus is further configured to determine a sequence of the broadcast data included in the additional signal based on the sequence information and align the broadcast data received from the broadcast transmitting apparatus based on the broadcast data included in the additional signal.

11. The system as claimed in claim 10, wherein the broadcast receiving apparatus is further configured to correct an error of the aligned broadcast data and output an image based on the broadcast data.

12. The system as claimed in claim 7, wherein the reference apparatus is further configured to transmit the additional signal to the broadcast receiving apparatus through at least one among Internet, Ethernet, Wi-Fi, Bluetooth or broadcast network of an idle broadcast band.

13. A method of controlling a broadcast receiving apparatus, the method comprising:
receiving a broadcast signal including broadcast data from a broadcast transmitting apparatus;
receiving an additional signal including broadcast data and header information regarding the broadcast data from a reference apparatus;
determining the broadcast data included in the additional signal based on the header information; and
aligning the broadcast data received from the broadcast transmitting apparatus using the broadcast data included in the additional signal.

14. The method as claimed in claim 13, wherein the header information includes pattern information indicating whether the broadcast data that the reference apparatus has received is contained and sequence information indicating a sequence of the broadcast data included in the additional signal.

15. The method as claimed in claim 14, wherein the determining comprises detecting the pattern information in the header information and, in response to the detected pattern information corresponding a preset pattern, determining that the reference apparatus has received the broadcast data the additional signal.

16. The method as claimed in claim 15, wherein the aligning comprises determining a sequence of the broadcast data included in the additional signal based on the sequence information and aligning the broadcast data received from the broadcast transmitting apparatus based on the broadcast data included in the additional signal.

17. The method as claimed in claim 16, further comprising correcting an error of the aligned broadcast data and outputting an image based on the broadcast data.

18. The method as claimed in claim 13, wherein the receiving from the reference apparatus comprises receiving the additional signal from the reference apparatus through at least one among Internet, Ethernet, Wi-Fi, Bluetooth or broadcast network of an idle broadcast band.
